(19) United States
(12) Patent Application Publication
(10) Pub. No.: US 2023/0075944 A1
(43) Pub. Date: Mar. 9, 2023

(54) REST Resilient Client-Server Reconciliation for Telecom Networks

(71) Applicant: Parallel Wireless, Inc., Nashua, NH (US)

(72) Inventors: Girish Desai, Pune (IN); Mukesh Singhal, Pune (IN); Raghu Kota, Bangalore (IN)

(21) Appl. No.: 17/819,945

(22) Filed: Aug. 15, 2022

Related U.S. Application Data
(60) Provisional application No. 63/232,914, filed on Aug. 13, 2021.

(51) Int. Cl. H04W 40/02

(52) U.S. Cl. CPC H04W 40/02; H04W 84/042

(57) ABSTRACT

A method is disclosed for client-server reconciliation for wireless telecommunication networks, comprising: determining, by a client system in a Radio Access Network (RAN) connected to a server in the RAN, a need for reconciliation with the server; terminating an HTTP connection; flushing a buffer; creating a current snapshot of the client system; sending the current snapshot to the server with an identifier for a particular server process; buffering a message at the client during reconciliation; sending a reconciliation complete message to the server to indicate that process has been completed and all the data from the client has been delivered to the server; and sending, by the client after the reconciliation is complete, the message that was buffered during the reconciliation to the server.

### CROSS-REFERENCE TO RELATED APPLICATIONS

This application claims priority under 35 U.S.C. § 119(e) to U.S. Provisional Patent Application No. 63/232,914, filed Aug. 13, 2021 and titled “REST Resilient Client-Server Reconciliation for Telecom Networks,” which is hereby incorporated in reference in its entirety for all purposes. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed October 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828427, U.S. Pat. App. Pub. Nos. US20170273134A1, US20170127409A1 in their entirety. Further details regarding some embodiments may be found in U.S. Pat. App. Publication Nos. US20200045565A1 and US20200042365A1, each of which are hereby incorporated by reference in their entirety for all purposes.

### BACKGROUND

Reconciliation is used to come out of a fault situation. e.g. a task has crashed and we are recovering from it. With a reconciliation procedure, the client would typically sync with a server.

REST and microservices are technologies that are being applied to the telecom stack in the context of 5G, but which originated in the web context.

### SUMMARY

A method is disclosed for client-server reconciliation for wireless telecommunication networks, comprising: determining, by a client system in a Radio Access Network (RAN) connected to a server in the RAN, a need for reconciliation with the server; terminating an HTTP connection; flushing a buffer; creating a current snapshot of the client system; sending the current snapshot to the server with an identifier for a particular server process; buffering a message at the client during reconciliation; sending a reconciliation complete message to the server to indicate that process has been completed and all the data from the client has been delivered to the server; and sending, by the client after the reconciliation is complete, the message that was buffered during the reconciliation to the server.

The RAN may comprise at least one of a 2G, 3G, 4G, LTE, Wi-Fi or 5G network. Request routing may be performed based on a predetermined URI that is sent as part of starting reconciliation. Reconciliation with multiple server processes is claimed. Reconciliation with a particular server app using particular information that is part of the current snapshot is claimed. A lightweight reconciliation start message may be used prior to sending the current snapshot to the server.

### BRIEF DESCRIPTION OF THE DRAWINGS

FIG. 1 is a sequence diagram of an exemplary method in accordance with some embodiments.

FIG. 2 is a sequence diagram of an exemplary method showing an eNodeB, in accordance with some embodiments.

FIGS. 3A and 3B show a reconciliation procedure in sequence diagram form, in accordance with some embodiments.

FIG. 4 shows a schematic network architecture diagram for 4G and other-G networks, in accordance with some embodiments.

FIG. 5 shows an enhanced eNodeB for performing the methods described herein, in accordance with some embodiments.

FIG. 6 shows a coordinating server for providing services and performing methods as described herein, in accordance with some embodiments.

### DETAILED DESCRIPTION

In telecom networks, irrespective of any technology there is at least one node which as a server controls multiple underlying nodes. This node may generate lot of time critical data and may have to deliver this data to some other server for taking further actions, in this case this node will act as a client. In this scenario client is the critical data generator and pushes this data to the server. HNG is normally a server for eNBs, etc. It also acts as a client toward the SON server and other servers, and syncs data up to those servers.

It is possible that client and server goes out of sync due to various reasons. Some of them are mentioned below:

Client starts/restarts; Client-server link goes down for significant time duration; Server is heavily loaded and drop some of the requests; Lossy network, some requests/responses are dropped; Slow network and lot of data is piled up at client—in this scenario, it is responsibility of client to detect the problem and bring server in sync.

With or without a reconciliation procedure, the client would typically sync with a server. Whenever the HTTP interface is available, we use this as a first step to send what is at the client to the server. We are describing herein, syncing states of eNBs, for example in 4G, the use case is whether a link is down (SCTP link or HTTP link); or a task on HNG has crashed and recovered. Now, the client has information that is not known whether it has been synced. (The source of truth is the client.) At the server side, the server will handle its fault, then learn what the state of the world is.

In order to bring server in sync, the current snapshot of the system needs to be sent to the server. As the nodes in telecom network are dynamic in nature, while the current snapshot is being delivered to the server it is possible that lot of other data is generated. As client and server are not in sync yet, this data cannot be sent towards server. This data needs to be buffered at client until the reconciliation process completes and it will be sent later.

We have proposed a 3-step reconciliation approach. This 3-step process is per resource (URI) basis. Each resource has a URI, e.g., eNB link state, configs, etc. Each URI has its own 3-step reconciliation process.

We don't know when the error situation will be corrected. Instead of sending a heavy packet with all the info in it, we start with a start message. Flush everything at the client: empty stored buffers, disconnect its own clients; verify E2E connectivity; send current snapshot to the server.

In the distributed architecture there would be different processes for handling different resources.

Reconcile-Start:

Whenever client decides that there is need for reconciliation, all the existing HTTP connections are terminated and all the available buffers are flushed. Basically all the existing messages stored and in transit are dropped. The client becomes a clean slate before starting the reconciliation.

A HTTP request with reconcile-start URI is sent on new connection. The reconcile-start URI would be designed in such a way that it is directed to specific process which is handling that particular resource. In this way we make sure that there is end to end connectivity is available for reconciliation. End to End connectivity would mean client application to server application are ready for reconciliation.

Most of the cases when reconciliation is triggered in that case the there is some or the other problem either at server or in network. If there is no end-to-end connectivity between client and server then we may not want to unnecessarily send large HTTP packet with entire system snapshot into the network which has low probability of success. To avoid this we use light weight reconcile-start message.

Any data generated during this step is ignored as we are going to send the latest snapshot of client state to server in next step.

Once we receive successful response for this message we move to the next step of reconciliation.

Reconciliation Snapshot:

Once reconcile-start is successful we get to know that server is ready for reconciliation and client creates a current snapshot of the system and sends towards the server. In case there is huge amount of data to be synced and the client may choose to do it in batches.

While delivering this reconciliation messages, it is possible that some other new data is generated by client but we cannot send this data as the latest system snapshot is already been created and it is in transit. We store this data in buffer, so that we can send it after successful response is received from server

In case there is failure in reconciliation, then we again move to step 1.

Reconciliation Complete:

We send reconciliation complete msg to server to indicate that process has been completed and all the data from client has been delivered to the server. Now both client and server are in sync for this particular resource and the server application go ahead with further actions.

After reconciling is complete, all the messages which were buffered during reconciliation phase are sent to the server.

The reconcile procedure for different URIs can happen in parallel as these resources are independent of each other.

Request routing. Based on a predetermined URI that is sent as part of the HTTP message/request, the server at other side would look at URI information and give it to the backend microservice. This enables multiplexing into the right server_app. The URI is thereby shared between server and client to allow them to identify the resource to be updated, according to REST semantics. Although HTTP REST semantics are shown here, it can be used for any HTTP interaction.

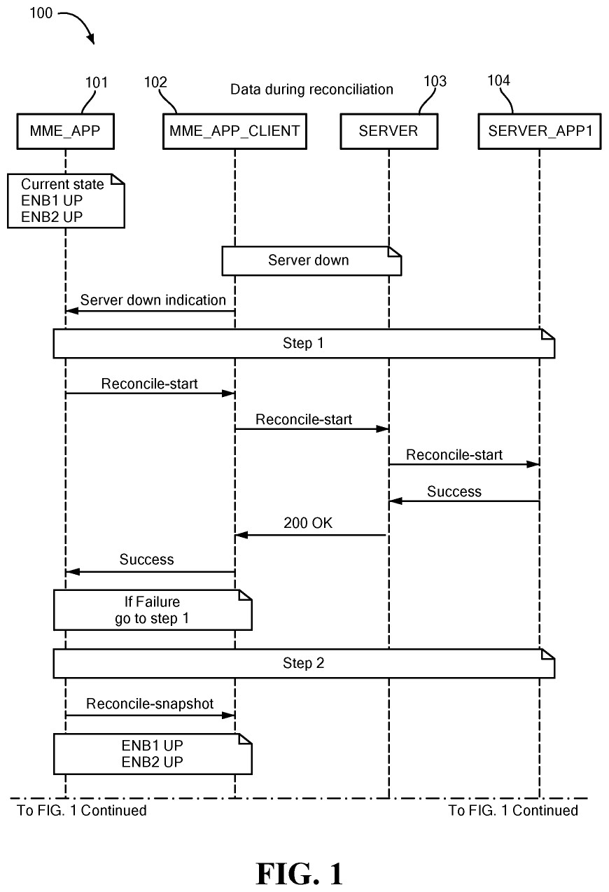

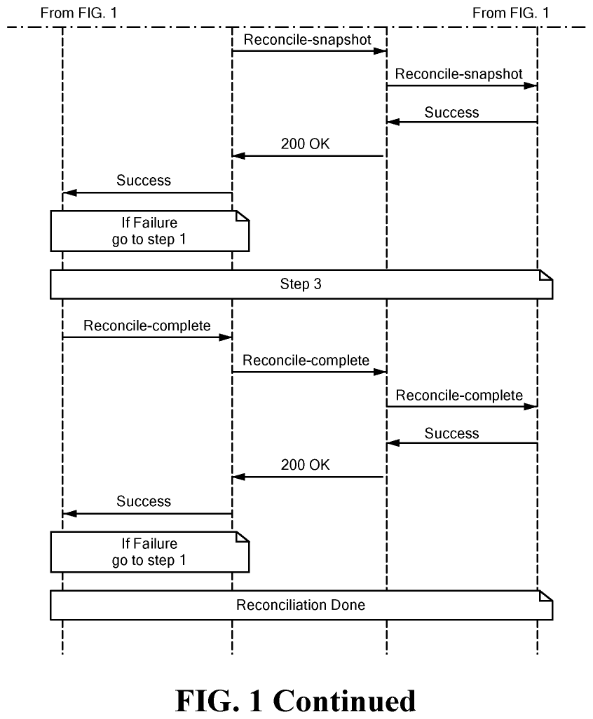

FIG. 1 is a sequence diagram of an exemplary method in accordance with some embodiments.

In some embodiments, Server 103 and Server_App1 104 may be on same machine; MME_App 101 and MME_App Client 102 may be on same machine; Diagram shows “enb1 up, enb2 up”—this is the state that is being shared to the backend application.

TCP connection between the MME APP CLIENT and Server but it's possible that there is no app ready to service the connection on behalf of Server App1

Check E2E client to server app connection.

STEP 1, Reconcile-Start

This is done on a per-URI basis, because sometimes the back-end task cannot be up or non-responsive. Using per-URI check allows us to separate the multiplexer from the back-end task

Let's gain the advantages of the microservice architecture, such as: resiliency, containerization, redundancy, fast start, orchestration.

If we assume the back-end is up based on the fact that the Server has TCP connection—this can result in message flooding where resources are being hogged but the server_app is not getting the data or data is expiring from cache

By contrast, using microservices architecture, client resources, server link resources are conserved.

STEP 2, Reconcile-Snapshot

App creates a current snapshot of the system, and it is sent to the server

It's possible there is a lot of data at the client. In that case we will have multiple messages. Loop on the data until it is all sent the server

STEP 3, Reconcile-Complete

Additional checksums and verification that data has been saved can be used to reconcile additional connections or to provide additional guarantees or trusted knowledge.

Success response is generated by the backend app (server app), which may be a particular server app.

This 3rd step is to explain that all messages from the client have been sent. In the case that the server is waiting for additional data to arrive. This is essentially an END message.

One idea is that this would be repeated for multiple necessary reconciliations, such that each server app is reconciled to the client.

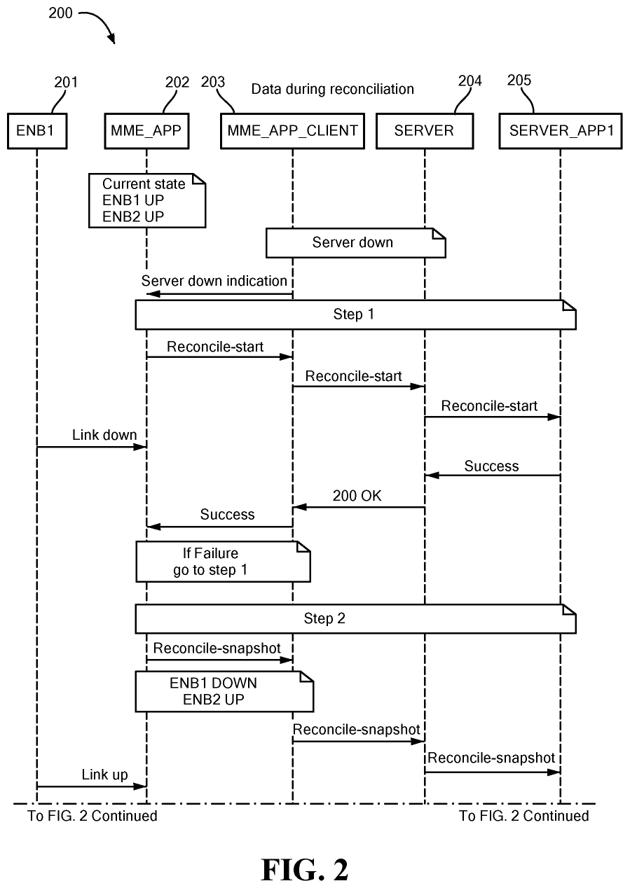

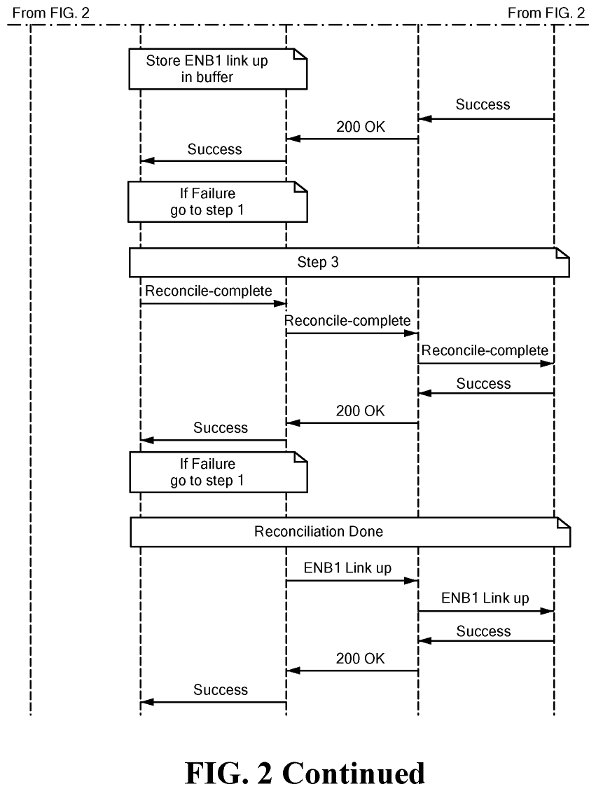

FIG. 2 is a sequence diagram of an exemplary method showing an eNodeB, in accordance with some embodiments. EnodeB1 201 is an additional node that is added to the example shown in FIG. 1 with MME_APP 202, MME_APP_CLIENT 203, SERVER 204, and SERVER_APP1 205.

Reconciliation can take a while. How do we handle additional changes to the data during the reconciliation process? We handle this scenario by creating a new snapshot after the in-progress reconciliation process has been completed.

FIG. 2 shows the state being changed from “ENB1 up, ENB2 up” to one of the ENBs going down (“Link down”). And further, going back up (“Link up”). The reconciliation process is in progress at the time the state is changed. However, these state changes are stored in a buffer at MME_APP.

A buffer can be overrun. Putting data into a buffer is therefore a practice to avoid. Only after reconcile-start is successful do we start to use the buffer for storing new state. Reconcile-start also allows us to avoid the use of a buffer until it is needed.

At some point it is possible that the true state is out of sync with the server. How to handle the latency between the reconciled data and the actual live data? There are two possibilities. In one scenario, the server_app microservice is down and out of sync. This is the problem for which this solution is well-suited. In the other scenario, as long as the out of sync is only within a small period of time, the present solution is able to quickly achieve sync. This is in contrast to the monolithic way of handling services typical in traditional telecom, in which there are alarms that are generated when a server goes down, but wherein great emphasis is given to maintaining server availability because it is so difficult and complex to bring up a server.

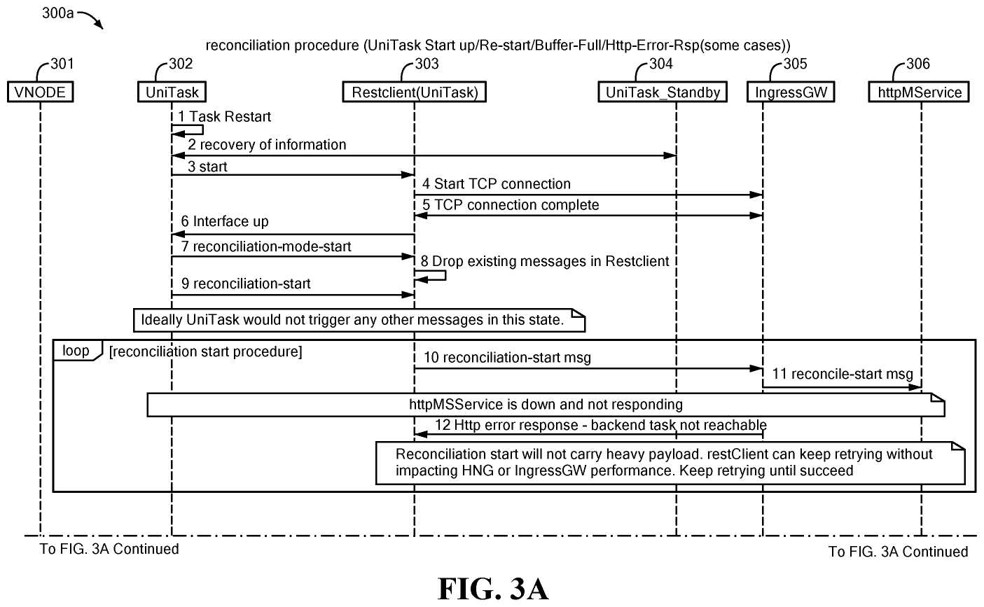

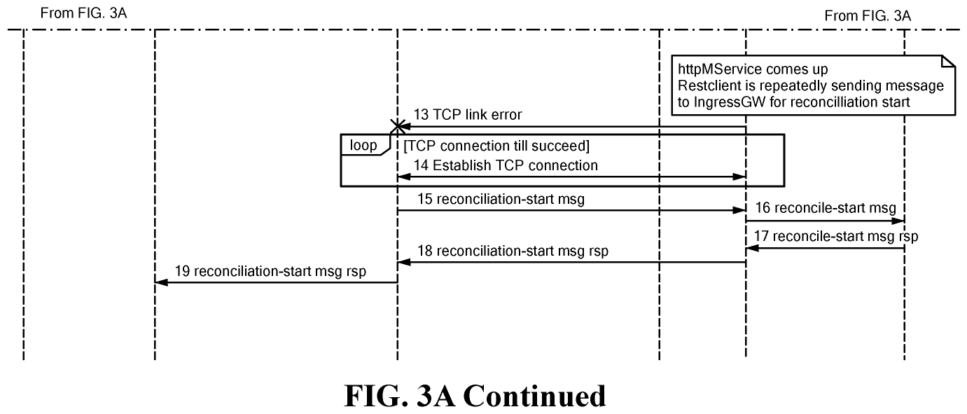

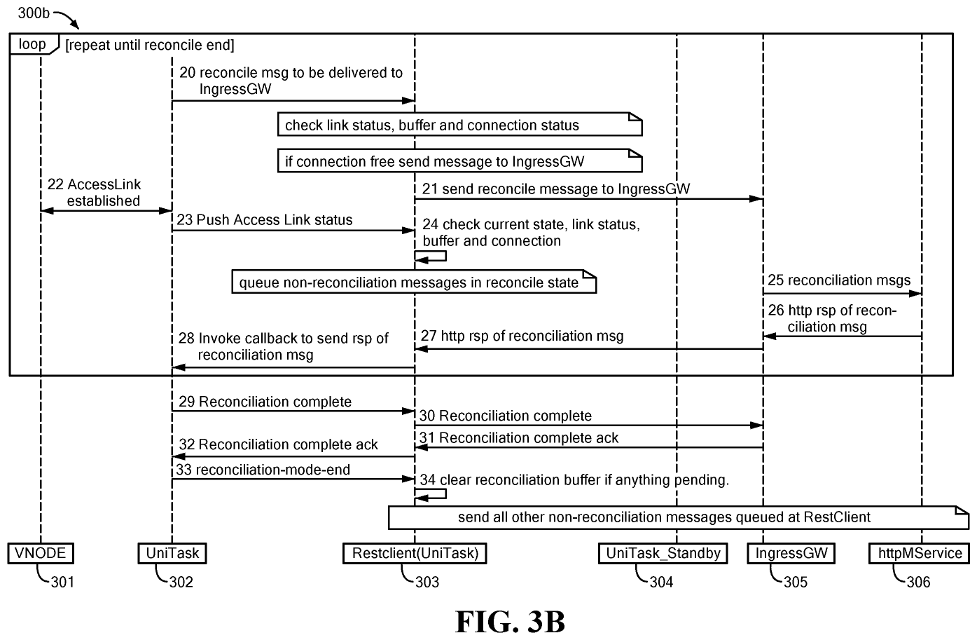

FIGS. 3A and 3B show a reconciliation procedure in sequence diagram form, in accordance with some embodiments.

Sequence diagram 300a shows vNode 301 (a virtual base station, such as an eNB or gNB that is virtualized), and various tasks that are part of a coordinating gateway, variously labeled UniTask 302, Restclient(Unitask)303, Unitask Standby 304, Ingressgw 305, and httpMservice 306. Unitask 302 provides services to vNode 301, acts as a proxy and gateway, and pushes various messages from the perspective of vNode 301 to the rest of the gateway. Restclient 303 is a task that focuses on providing http access to the server to Unitask 302, such that connections are made available using a REST semantic; as such, it handles HTTP errors, establishes HTTP connections and TCP connections, and promulgates information about link error states, and queues messages. Unitask standby 304 provides an interface to Unitask 302 and is active during a standby scenario, which is not further described here. IngressGW 305 provides routing to httpMService 306, and httpMService 306 is the HTTP service providing REST semantic protocol access to the coordinating gateway. In brief summary, Unitask 302 initiates reconciliation, and then Restclient 303 sends reconciliation messages and httpMService 306 responds to the messages until reconciliation is achieved.

FIG. 4 shows a schematic network architecture diagram for 4G and other-G networks, in accordance with some embodiments. Shown above is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. The present invention is also applicable for 5G networks since the same or equivalent functions are available in 5G. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

FIG. 5 shows an enhanced eNodeB for performing the methods described herein, in accordance with some embodiments.

Shown is an enhanced eNodeB for performing the methods described herein, in accordance with some embodiments. eNodeB 500 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

FIG. 6 shows a coordinating server for providing services and performing methods as described herein, in accordance with some embodiments.

Shown above is a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for client-server reconciliation for wireless telecommunication networks, comprising:
determining, by a client system in a Radio Access Network (RAN) connected to a server in the RAN, a need for reconciliation with the server;
terminating an HTTP connection;
flushing a buffer;
creating a current snapshot of the client system;
sending the current snapshot to the server with an identifier for a particular server process;
buffering a message at the client during reconciliation;
sending a reconciliation complete message to the server to indicate that process has been completed and all the data from the client has been delivered to the server; and
sending, by the client after the reconciliation is complete, the message that was buffered during the reconciliation to the server.

2. The method of claim 1, wherein the RAN comprises at least one of a 2G, 3G, 4G, LTE, Wi-Fi or 5G network.

3. The method of claim 1, further comprising request routing based on a predetermined URI that is sent as part of starting reconciliation.

4. The method of claim 1, further comprising reconciliation with multiple server processes.

5. The method of claim 1, further comprising reconciliation with a particular server app using particular information that is part of the current snapshot.

6. The method of claim 1, further comprising using a lightweight reconciliation start message prior to sending the current snapshot to the server.
